(19) United States
(12) Patent Application Publication
(10) Pub. No.: US 2008/0244758 A1
(43) Pub. Date: Oct. 2, 2008

(54) SYSTEMS AND METHODS FOR SECURE ASSOCIATION OF HARDWARD DEVICES

(76) Inventors: Ravi Sahita, Beaverton, OR (US); Hormuzd M. Khosravi, Portland, OR (US); Uday Savagaonkar, Hillsboro, OR (US); David M. Durham, Beaverton, OR (US)

Correspondence Address: SCHWEGMAN, LUNDBERG & WOESSNER, P.A., P.O. BOX 2938, MINNEAPOLIS, MN, 55402, US

(21) Appl. No.: 11/694,548

(22) Filed: Mar. 30, 2007

(51) Int. Cl. G06F 1/26; G06F 9/26

(52) U.S. Cl. 726/34; 711/206; 711/E12.002

(57) ABSTRACT

An apparatus to protect one or more hardware devices from unauthorized software access is described herein and comprises, in one embodiment, a virtual machine manager, a memory protection module and an integrity measurement manager. In a further embodiment, a method of providing secure access to one or more hardware devices may include, modifying a page table, verifying the integrity of a device driver, and providing memory protection to the device driver if the device driver is verified.

### TECHNICAL FIELD

Systems and methods for hardware device management are described herein, and more particularly, systems and methods for secure association of hardware devices.

### BACKGROUND

Systems and methods are present in one or more currently shipping operating systems that provide for the secure execution of software components. Exploits within these software components and attacks on them represent very large security risks in individual systems, specifically, and in larger networked systems. Though the system as a whole is protected from attack, the interoperability with weaker software components can create an insecure system.

### BRIEF DESCRIPTION OF THE DRAWINGS

The drawings illustrate generally, by way of example, but not by way of limitation, various embodiments discussed in the present document.

FIG. 1 shows a high level block diagram of a system, in accordance with an embodiment of the present invention;

FIG. 2 shows a high level block diagram of an apparatus, in accordance with an example embodiment of the present invention; and

FIG. 3 shows a flowchart of a method, in accordance with an example embodiment of the present invention.

### DETAILED DESCRIPTION

In the following detailed description of embodiments of the invention, reference is made to the accompanying drawings which form a part hereof, and in which are shown, by way of illustration, specific preferred embodiments in which the subject matter may be practiced. These embodiments are described in sufficient detail to enable those skilled in the art to practice them, and it is to be understood that other embodiments may be utilized and that logical, mechanical, and electrical changes may be made without departing from the spirit and scope of the present disclosure. Such embodiments of the inventive subject matter may be referred to, individually and/or collectively, herein by the term “invention” merely for convenience and without intending to voluntarily limit the scope of this application to any single invention or inventive concept if more than one is in fact disclosed.

In an embodiment, the methods and apparatus described herein provide a framework in which only authorized software components are able to access and/or modify the state of a hardware device coupled to the computing system. Traditionally, virtualization technologies have focused on provide virtualized and isolated environments in which software components are executed by prevented from accessing or modifying the state of another software component. The methods and apparatus described herein extend that protection to device drivers, which are software components executed within one of the virtualized machines that provide access to one or more hardware devices.

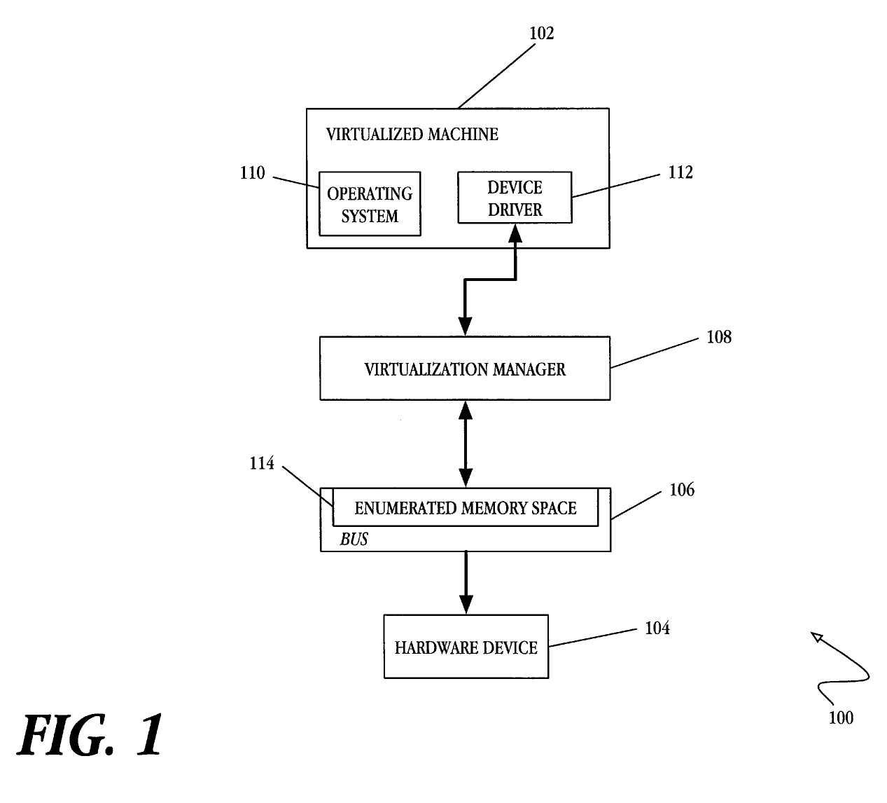

FIG. 1 shows a block diagram of a system, in accordance with embodiments, of the present invention. The system 100 comprises a virtualized machine 102 communicatively coupled to a hardware device 104 through a communications bus 106 and a virtualization manager 108. In an embodiment, the virtualization manager is executed from within an isolated execution environment. As used herein, an “isolated execution environment” is an execution environment that is configured to execute code independently and securely isolated from a host, the virtualized machine 102 in this example, which it is communicatively coupled to. In a further embodiment, the isolated execution environment is further configured to prevent software running on the host from performing operations that would alter, modify, read, or otherwise affect the code store or executable code that is running in the isolated execution environment. In the context of the present application, the virtualization manager 108 is executed inside an isolated execution environment which prevents all software executed by the virtualized machine 102 from altering or reading any instructions contained on the virtualization manager 108. The virtualization manager may also be referred to as a virtual machine manager, in some embodiments.

It should be understood that though only one virtualized machine 102 and one hardware device 104 are depicted, more than one of each may be executed concurrently. So one virtualized machine 102 may be accessing more than one hardware device 104 concurrently, and conversely, one hardware device 104 may be concurrently access by one or more virtualized machines 102. The virtualized machines may execute, without limitation, an operating system 110 and a device driver 112. The device driver 112, in one embodiment, provides access to a hardware device 104. For example, in the case of a network interface card, the network driver would be executed within the virtualized machine 102 and provide access to the network interface card and to the network, to the virtualized machine and any application executed therein.

The virtualization manager 108 provides access to the one or more hardware devices 104 through a bus. This bus may represent one or more buses, and may include without limitation, peripheral component interconnection (PCI), PCI-e, PCI-X, or any other communications bus that provides an enumerated memory space 114 to the virtualization manager 108.

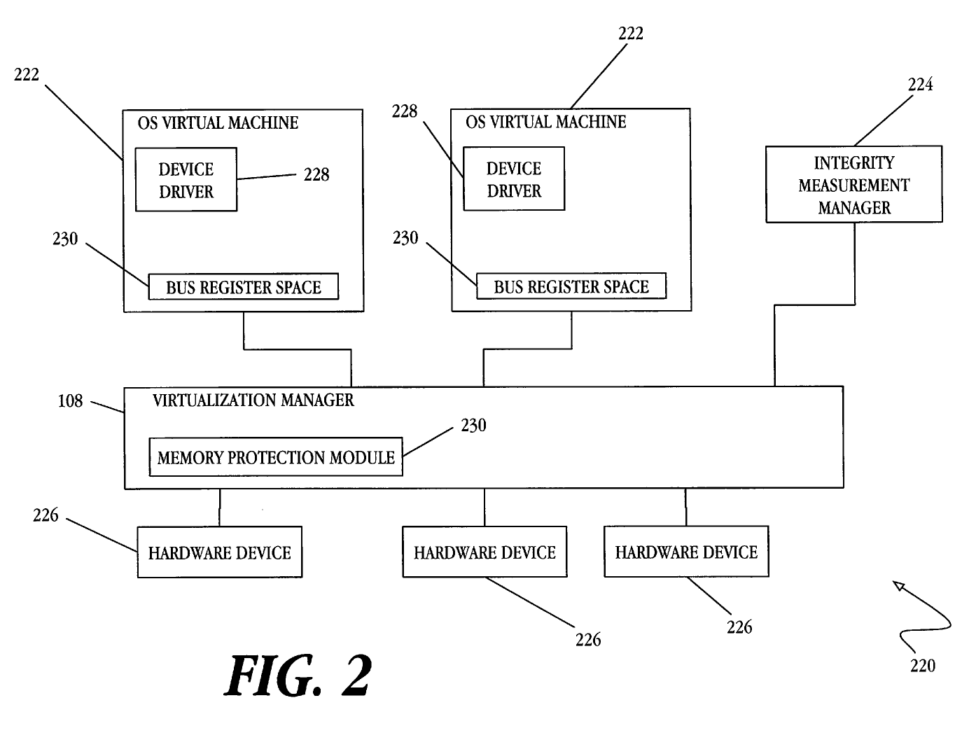

FIG. 2 shows a high level block diagram of an apparatus, in accordance with an example embodiment of the present invention. The apparatus 220 includes one or more OS virtual machines 222 communicatively coupled to a virtualization manager 108. Additionally, an integrity measurement manager 224 may be coupled to the virtualization manager 108, in one embodiment. One or more hardware devices 226 are coupled to the virtualization manager 108. This may be, as discussed above, through a communications bus.

The one or more virtual machines include a device driver 228 and bus register space 230, in an embodiment. The device driver 228 accessing a hardware device 226 will attempt to access an address within the bus register space 230, which is virtualized. The OS virtual machine 222 passes that access to the virtualization manager 108, which can be intercepted using the methods described herein, and managed by a memory protection module 230 executed within the virtualization manager 108.

In an embodiment, the integrity measurement manager 224 is coupled to the virtualization manager 108 and is configured to measure and manager the integrity of the device drivers 228 executed within the OS virtual machine 222. In an embodiment, the integrity measurement manager measures the integrity of the device driver at runtime by inspecting its code/data image in memory and comparing it against a pre-defined manifest for that agent. In this example, the integrity measurement manager 224 provides to the virtualization manager 108 an ability to verify whether the device driver 228 loaded to the memory is really the component that the platform administrator intended to load to the memory.

In an embodiment, the memory protection module 230 executed within the virtualization manager 108 is configured to monitor the memory state of the virtualization manager 108. The memory protection module 230, in a further embodiment, is configured to provide memory protection to one or more device drivers 228 executed within one or more OS virtual machines 222. Protection may include, without limitation: protection from modification, so that the code of a protected software component cannot be modified by other software components; protection from eavesdropping, so that the code of a protected software component cannot be observed by other software components; and protection from control-flow attacks, so that the code of a protected software component can only be invoked or executed by other software components only at intended entry points that are monitored. To accomplish these protections, the memory protection module 230, in an embodiment, leverages memory-management capabilities of the virtualization manager. For example, the intra-partitioning performed by the virtualization manager 108 to execute one or more OS virtual machines can associate physical memory with a software component, such as a device driver 228, and can ensure that no component other than the associated software component can access that memory region. The virtualization manager controls the bus configuration using any suitable method. Combining that control with the capabilities of the memory protection module, as described herein, the hardware devices 226 are protected from unauthorized access by arbitrary software components.

In a further embodiment, these protections can be extended across a network of interconnected machines, wherein the communications bus is the network itself, and that access to one or more hardware devices across that network can be monitored, verified and protected using the systems and methods described herein.

In an embodiment, the management device 104 is configured to be executed inside an isolated execution environment. In an embodiment, an “isolated execution environment” is an execution environment that is configured to execute code independently and securely isolated from a host that it is communicatively coupled to. In a further embodiment, the isolated execution environment is further configured to prevent software running on the host from performing operations that would alter, modify, read, or otherwise affect the code store or executable code that is running in the isolated execution environment. In the context of the present application, the management device 104 is executed inside an isolated execution environment which prevents all software executed by the host device 102 from altering or reading any instructions contained on the management device 104.

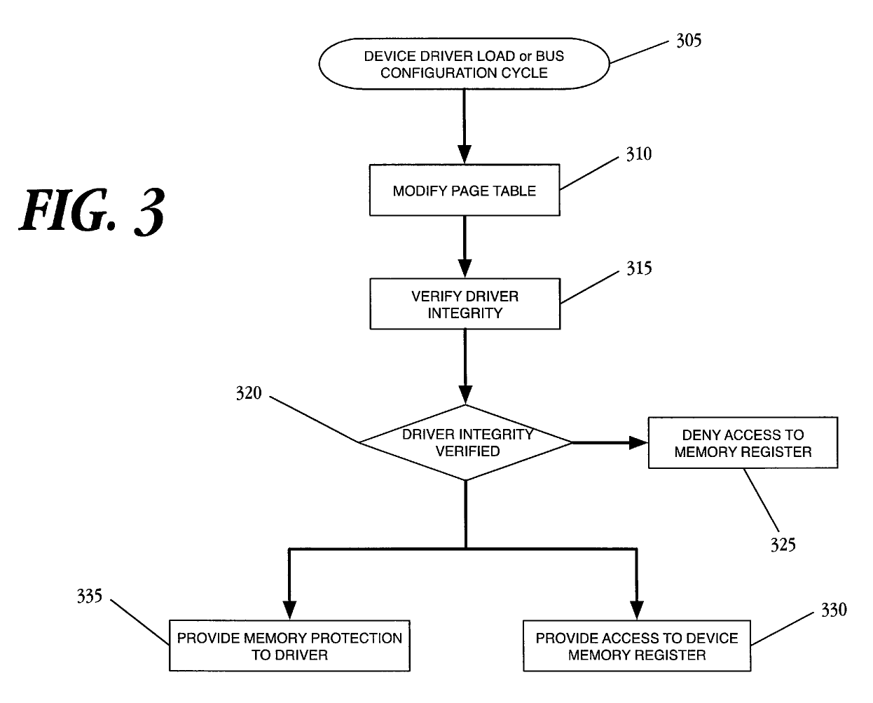

FIG. 3 shows a flowchart of a method, according to an embodiment of the present invention. The method depicted in FIG. 3 may be carried out by apparatus as described above, in some embodiments.

At block 305, the operations depicted in FIG. 3 commence with either a device driver being executed or a bus configuration cycle. As discussed above, the bus may include any bus that provides interconnection between one or more hardware devices and provides an enumerated memory space. At block 310, the virtualization manager 108 modifies the page table, protecting all hardware devices from any unprotected or unverified device driver. If, at block 305, a device driver is identified as being loaded, or requiring loading, the integrity measurement manager verifies the integrity of the driver at block 315. In one embodiment, the integrity measurement manager verifies the integrity of the driver by inspecting its code, or data image in memory, and comparing it against a pre-defined manifest for that driver. The pre-defined manifest can be stored locally and accessible to the integrity measurement manager, in one example. Alternately, the pre-defined manifest could be stored remotely and accessed across a network by the integrity measurement manager. Through these operations, the integrity measurement manager verifies that a particular software component, a device driver in this case, is the component that should have protected access to one or more hardware devices.

If the integrity of the device driver is not verified at block 320, the driver is denied access to that memory space at block 325, and thereby prevented from accessing or controlling the hardware device.

If the integrity of the device driver is verified at block 320, access to the memory register address of the hardware device is granted at block 330. Additionally, at block 335, the device driver is provided memory protection. In one embodiment, the memory protection module provides this protection. In a further embodiment, the memory protection module provides memory protection to the device driver by creating a separate set of protected page tables. This may include a separate set of IA-32-64 page tables, in one example. In this embodiment, the driver is mapped solely in those page tables. In an alternate embodiment, a separate set of extended page tables are used.

In a further embodiment, the operations depicted in FIG. 3 may be repeated during a configuration cycle for one or more device drivers loaded into memory. Additionally, if the device driver is unloaded from memory, the operations depicted in FIG. 3 are performed when the driver is next loaded into memory.

### EXAMPLE IMPLEMENTATION

An example using the systems and methods described herein can now be described. For example, access to the network interface card (NIC) can be controlled. Only drivers authorized, such as drivers that implement network outbreak containment (NOC), are afforded access to the NIC. In the absence of the controls and protections described herein, there is no mechanism of ensuring that rogue software does not hijack the NIC and send out traffic without enforcing NOC. To further explain, using the example of the network driver, NOC is a part of active memory technology, as is well known in the art, and provides a set of hardware filters (for desktop platforms) that are tamper resistant and can be configured by networking staff using out-of-band (OOB) to cut a platform off the network if its infected by worm or virus and spreading that through the enterprise. For wireless platforms however, due to certain limitations, the NOC filters were implemented in software by the network driver (miniport driver), and thus, if worms and viruses access the underlying NIC hardware directly, they can circumvent the NOC functionality completely. Conversely, the mechanisms presented herein enable driver writers to implement the NOC filters in the driver, and configure the platform in such a way that the network interface controller is accessible by only such a driver.

Another aspect concerning the present application is protecting the full packet path through the network stack: There are many types of attacks that can be launched at different “hook” points in the network stack. Examples of such attacks are: circumvention of a driver by inserting malicious drivers around it; insertion attacks where a standard API is called by malware to insert malicious payloads amongst non-malicious data streams; tamper of packet data in flight; and direct access to network hardware to refer to malicious payload instead of non-malicious traffic payloads. Using the methods and systems described herein to protect devices from malicious driver access, a protected network stack can be built on top of the protected network driver. This stack prevents the attacks described above by allowing only one entry point for data into the stack and preventing insertion at the other points in the stack all the way down to hardware registers (for example, PCI(e) register space for a network interface card (NIC) or a Lan on motherboard (LOM). Similar software stacks can be built for other hardware devices. Note that the approach also protects data that is shared between two logical partitions via memory which may be RAM or physical device registers.

There are further advantages of the present system, in that it: allows device registers to be exclusively associated with a corresponding verified driver that owns this device; it extends hardware feature set with software because hardware cannot be accessed without going through verified device driver software; the method described has no OS dependence; and this does not require any modifications to legacy drivers to take advantage of it.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, a computing device includes one or more processing elements coupled with computer-readable memory that may be volatile or non-volatile memory or a combination thereof.

Some embodiments of the invention may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for storing or transmitting information in a form readable by a machine (e.g., a computer). For example, a machine-readable medium may include read-only memory (ROM), random-access memory (RAM), magnetic disk storage media, optical storage media, flash-memory devices, and others.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus to protect hardware devices from malicious software attacks, comprising:
a virtual machine manager interposed between one or more operating system virtual machines and one or more hardware devices;
a memory protection module executed within the virtual machine manager to monitor the memory state of the virtual machine manager; and
an integrity measurement manager to measure and manage the integrity of one or more device drivers executed within the one or more operating system virtual machines, the device drivers accessing enumerated memory space managed by the memory protection module.

2. The apparatus of claim 1, wherein the memory protection module is configured to managed the enumerated memory space by providing memory protection to the virtual machine manager.

3. The apparatus of claim 2, wherein the memory protection include at least one of the following: protection from modification, protection from eavesdropping, and protection from control-flow attacks.

4. The apparatus of claim 1, wherein the integrity measurement module manages the integrity through the execution of instructions intended to inspect an image of the device driver in memory and compare the image with a pre-defined manifest for the device driver.

5. The apparatus of claim 1, wherein the one or more hardware devices are coupled to the virtual machine manager through a bus providing an enumerated memory space that can be mapped to the memory state of the virtual machine manager.

6. The apparatus of claim 1, wherein the integrity measurement manager is executed within an isolated execution environment.

7. The apparatus of claim 1, wherein the integrity measurement manager is executed within the virtualization machine manager.

8. A method, comprising:
modifying a page table so that the physical address for a hardware device is inaccessible to an operating system virtual machine;
verifying the integrity of a device driver attempting to access the physical address of the hardware device; and
providing memory protection and device memory registers to the device driver if the integrity is verified.

9. The method of claim 8, wherein the page table is modified in response to the interception by a virtual machine manager of a configuration cycle.

10. The method of claim 9, wherein the configuration cycle is a bus configuration cycle, the bus having an enumerated memory space.

11. The method of claim 8, wherein providing memory protection includes at least one of the following:
creating a set of protected page tables, wherein the device driver is mapped to an address in the protected page tables; or
using a set of extended page tables.

12. The method of claim 8, further comprising:
detecting a reload of the device driver and repeating.

13. A machine-readable medium having machine-executable instructions contained therein, which when executed perform the following operations
modifying a page table so that the physical address for a hardware device is inaccessible to an operating system virtual machine;
verifying the integrity of a device driver attempting to access the physical address of the hardware device; and
providing memory protection and device memory registers to the device driver if the integrity is verified.

14. The machine-readable medium of claim 13, wherein the page table is modified in response to the interception by a virtual machine manager of a configuration cycle.

15. The machine-readable medium of claim 14, wherein the configuration cycle is a bus configuration cycle, the bus having an enumerated memory space.
